(19) United States
(12) Patent Application Publication
(10) Pub. No.: US 2007/0137766 A1
(43) Pub. Date: Jun. 21, 2007

(54) Method for producing helical synchronous belt, and helical synchronous belt produced by same

(76) Inventors: Kiyotaka Matsuda, Kobe-shi, Hyogo (JP); Takashi Oota, Kobe-shi, Hyogo (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/595,804

(22) PCT Filed: Nov. 30, 2004
(86) PCT No.: PCT/JP04/18109

§ 371 Date: Jun. 12, 2006

(30) Foreign Application Priority Data
Dec. 2, 2003 (JP) 2003-403239

(51) Int. Cl. F16G 1/00

(52) U.S. Cl. 156/137

(57) ABSTRACT

To develop a helical synchronous belt for driving carriage that does not generate tracking due to the effect of helical teeth, in order to prevent lower positioning accuracy, vibration associated with reciprocating movement and reduced durability of the belt as a result of contact with the flange on the pulley's side face. The core cord twist angle of the helical synchronous belt is set to a value opposing to the helical tooth angle, with the helical tooth angle set to 5° to 15°, and core cord twist angle set to 15° to 2°.

### FIELD OF THE INVENTION

This invention relates to a driving belt with helical teeth. This type of driving belt is used mainly in printers, copiers, etc., for producing reciprocating movements of a carriage or other similar component to ensure precise positioning of printed text.

### DESCRIPTION OF THE RELATED ART

Meshing of a synchronous belt and pulley teeth is used as a means for transmitting power and controlling the position of a carriage equipped with a printer-head. This synchronous belt is suitable for achieving precise positioning control, and many equipment utilizing synchronous belts are used in offices and general homes with the advancement of information technology and diffusion of computers.

However, these synchronous belts have drawbacks, such as noise problem and driving irregularities occurring during operation, which have negative impact on the work environment in offices or living environment in general homes. As a means for reducing the noise and driving irregularities of synchronous belts, helical synchronous belts having helical teeth were developed and put to use.

A helical synchronous belt generates less noise, because the belt tooth does not simultaneously contact the pulley tooth along the entire length of the tooth.

While reducing noise, however, helical teeth that are formed at an angle to the pulley's rotating axis generate a force to offset the belt side tracking. This poses a problem of tracking.

A higher tracking force of a helical synchronous belt results in problems, such as lower positioning accuracy, vibration associated with reciprocating movement, and reduced durability of the belt as a result of contact with the flange on the pulley's side face.

A drive mechanism using a helical synchronous belt is explained briefly using FIG. 1 through 3. A helical synchronous belt has teeth formed at an angle to the pulley's rotating axis (inevitably, the pulleys used with a helical synchronous belt also have helical teeth formed at an angle to the pulley's rotating axis). This design generates a thrust force in the axial direction, and therefore the belt is tracking toward the downstream side of the driving pulley's inclination.

As shown in FIG. 1, the basic structure of a helical synchronous belt for driving carriage consists of a driving pulley (1), driven pulley (2), and helical synchronous belt (3). A carriage (8) having a printer-head, etc., is installed on the belt and caused to move back and forth. The driving pulley (1) and driven pulley (2) have flanges (7) to prevent detachment As shown in FIG. 2, the teeth on the helical synchronous belt (3), formed at an angle to the pulley's axis, mesh with the helical teeth on the pulleys as the belt is driven. This helical synchronous belt produces less noise from driving. However, the belt is subject to tracking along the inclination of the teeth, as shown in FIG. 3., because its teeth are formed at an angle to the pulley's rotating axis and therefore a thrust force is generated. This tracking causes the belt to contact the flange, resulting in wear and reduced durability.

A tracking belt also makes the contact pressure between the pulley and belt non-uniform in the width direction of the belt and consequently produces vibration. As the belt skews, the carriage will also tilt and disturb the printing action.

A number of measures have been proposed to solve this problem.

For example, Japanese Patent Application Laid-open No. 10-153240 proposes a synchronous belt, which is formed in such a way that the core cords (27) are twisted in a single direction corresponding to the inclination direction of the tooth trace, so that the driving force generated by the drive motor will be smoothly transmitted to the carriage to achieve stable driving action, and consequentially, higher recording quality. The invention also proposes a printer-carriage drive mechanism that uses said synchronous belt The effect of this invention is that because the inclination direction of the tooth trace of the driving gear is opposite to the inclination direction of the tooth trace of the driving pulley, the thrust force generated in the axial direction of the driving pulley and driving gear by the helical gear teeth can be mitigated. As a result, the belt can maintain higher reliability for a longer period. In addition, by forming the helical teeth of the synchronous belt in such a way that their tooth trace is twisted in the same direction as the twist direction of the core cords comprising the synchronous belt, the thrust force generated in the width direction as a result of slant meshing of the synchronous belt with the driving pulley and driven pulley can be tracking against the twisting force of the core cords. This is some of the excellent effects offered by the aforementioned invention as disclosed in the literature.

In Japanese Patent Application Laid-open No. 10184808, a helical synchronous timing belt is provided that can significantly reduce the vibration caused by the friction with the flanges of the toothed pulleys around which the timing belt rotates; wherein (a) said helical tooth timing belt consists of core cords buried in the belt base and canvas attached on the tooth face side of the aforementioned belt base; (b) the inclination of the core cords and that of the grains of canvas are set in the opposite direction to the inclination of the tooth trace of belt teeth with reference to the running direction of the belt; and (c) the core cords are twisted in S-pattern if the belt teeth are inclined upward in clockwise direction or downward in counterclockwise direction with respect to the running direction of the belt representing the vertical reference line, or in Z-pattern if the belt teeth are inclined upward in counterclockwise direction or downward in clockwise direction. The helical synchronous timing belt provided by this invention allows the thrust force generated by the belt teeth having an inclined tooth trace to be tracking by the thrust force generated from the core cords and canvas, and as a result the overall thrust force generated by the belt is reduced.

Earlier in Japanese Patent Application Laid-open No. 62-11222, the inventor of the present invention proposed an invention that suppresses belt tracking caused by the running of the belt To do this, the ridgeline of a twill woven cloth is inclined in the opposite direction to the inclination of the tension cord with respect to the running direction of the belt, so that the thrust force generated by the contact of the canvas and pulleys can be used to reduce the tracking force resulting from the inclination of the tension cord.

In Japanese Patent Application Laid-open No. 2001-159449, the applicant of the present invention proposed a helical synchronous belt drive system consisting of a helical synchronous belt as well as a driving pulley and a driven pulley around which the belt is wound, with the aim of keeping the helical synchronous belt from tracking during the operation of the belt and also with the aim of preventing noise or wear on the belt side caused by the sliding of the belt side face against the flange; wherein said helical synchronous belt drive system is designed in such a way that the contact area of the belt tooth and pulley groove will increase gradually from the start to end of meshing of the helical synchronous belt with the driving pulley and driven pulley. This invention intends to limit thrust force generation by reducing the contact of the helical teeth of the belt and the helical teeth of the pulleys, and thereby limiting the friction area on both teeth.

### SUMMARY OF THE INVENTION

The present invention is intended to develop a helical synchronous belt for driving carriage that does not generate tracking due to the effect of helical teeth, in order to prevent lower positioning accuracy, vibration associated with back and forth movement, and reduced durability of the belt as a result of contact with the flange on the pulley's side face.

In developing the present invention, the inventor focused on the twisted core cords as a contributing factor of belt tracking and found that the tracking force could be reduced by changing the number of twists of the core cord. To be specific, a more complete invention in terms of its fitness to practical use was proposed by specifying the core cord twisting method by the twist angle.

(1) A method for producing a helical synchronous belt, wherein said helical synchronous belt for driving carriage comprises a back layer, teeth and core cords, each made of a synthetic resin, and the thrust force exerted on the helical synchronous belt due to the twist angle of the core cord is measured using the strain gauge provided on the driving pulley in order to determine the helical tooth angle and core cord twist angle.

(2) A helical synchronous belt having its core cords twisted at an angle opposing to the angle of helical teeth, with the helical tooth angle set to 5° to 15° and core cord twist angle set to 15° to 2°.

(3) A helical synchronous belt as described in (2), having a helical tooth angle of 10°, 7° or 5° and core cord twist angle of 10.2° or 4.8°.

(4) A helical synchronous belt as described in (2) or (3), with its back layer and teeth made of urethane resin and its core cords made of aramid fiber or glass fiber.

(5) A helical synchronous belt as described in (2), (3) or (4), used primarily for driving a carriage.

### BRIEF DESCRIPTION OF THE DRAWINGS

FIG. 1 is a drawing illustrating the drive mechanism of a general helical synchronous belt for driving carriage.

FIG. 2 is an oblique view of a helical synchronous belt and a pulley.

FIG. 3 is a drawing illustrating the tracking mechanism of a helical synchronous belt.

FIG. 4 is a schematic illustration of a helical synchronous belt covered with canvas.

FIG. 5 is a schematic illustration of a helical synchronous belt not covered with canvas.

FIG. 6 is a view showing twist directions of twines.

FIG. 7 is a schematic illustration of a belt's helical tooth angle and core cord twist angle.

FIG. 8 is a drawing illustrating a device to measure tracking force.

FIG. 9 is a graph of measured tracking force and durability.

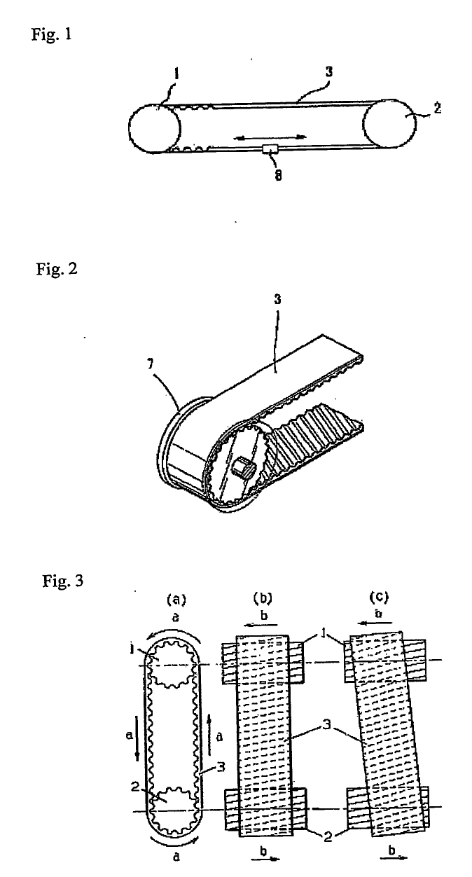

### DESCRIPTION OF THE SYMBOLS

1: Driving pulley

2: Driven pulley

3: Helical synchronous belt

4: Tracking direction

a: Rotating direction

4: Tooth

5: Back layer

6: Core cord

7: Flange

8: Carriage

9: Canvas

d: Helical tooth angle

β: Twist angle

L1: Pulley axial direction line

4a: Tooth inclination line

6a: Twist inclination line

41: Strain gauge

42: Bridge

43: Amplifier

44: FFT

45: PC

### BEST MODE FOR CARRYING OUT THE INVENTION

The helical synchronous belt used in the present invention comprises teeth (4), back layer (5) and core cords (6). The core cords (6) are buried in the back layer (5) on the tooth (4) side.

Although not illustrated, this positioning relationship allows core cords to be wrapped around a cylindrical mold having a circumference equal to the belt length and also having a mold for female helical teeth attached on it Then, this core cord-wrapped cylinder is covered by an outer cylinder mold of a size large enough to provide a void equivalent to the thickness of the belt back and then synthetic resin is injected into the cavity. When resin cures, the molds are removed and the formed product is cut to the belt width to form a helical synchronous belt of a ring shape. Since core cords are wrapped around a cylinder with a mold for female helical teeth attached on it, the finished belt has its core cords positioned near the surface of the back layer on the tooth side. Synthetic resin is injected and filled into the space between the back layer and teeth, so the back layer and teeth are formed integrally.

With a helical synchronous belt having the above structure, the bottoms between belt teeth contact the tops of pulley teeth. The helical synchronous belt shown in FIG. 5 is an example of the helical synchronous belt structure used in the present invention. The back layer and teeth are made of the same resin, and the core cords are positioned in the back layer on the tooth side.

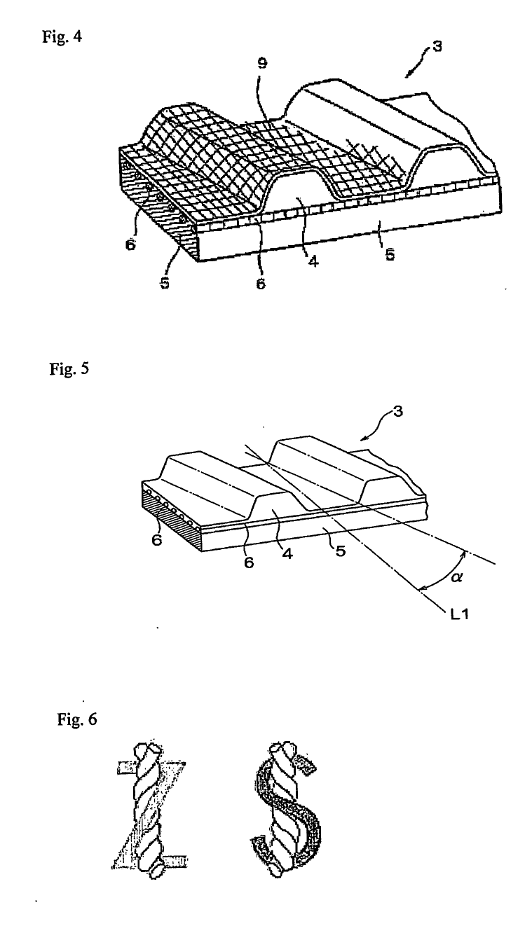

FIG. 4 shows another example of belt structure, where canvas (9) is attached on the belt surface on the tooth side.

The belt described in Patent Literature 2 as cited in the explanation of conventional belts is of this type. When canvas is attached, however, the canvas contacts the pulley and therefore the belt is affected by the friction between the pulley and canvas. The belt is also affected by the weaving of the canvas. Therefore, this type of structure is not suitable for applying the present invention.

The core cords of the belt use twines made by twisting several cords together.

Twines are classified into right-handed twist (Z-twist) and left-handed twist (S-twist) depending on the twist direction. As shown in FIG. 6, a right-handed twist is twisted upward in clockwise direction, while a left-handed twist is twisted upward in counterclockwise direction. Normally belt core cords are made of one left-handed twist and one right-handed twist wound together. As for examples of conventional belts of this type, refer to Japanese Patent Application Laid-open No. 10-278127 and others for descriptions of belt production processes and winding of left-handed twist and right-handed twist (refer to FIG. 11 in Japanese Patent Application Laid-open No. 10-278127).

The present invention aims to generate resistance to the thrust force exerted on the helical synchronous belt by paying attention to the twisting of twines used as core cords.

When a driving force is applied to the belt and tension generates, the core cords also receive the tension. When pulled, the twines comprising the core cords generate a rotational moment in the direction of tightening the twist.

The inventor considered that the surface irregularities created by the twisting of the core cords would contact the tops of pulley teeth, thereby generating friction and resistance against sliding. These surface irregularities also change the friction resistance, because the contact angle and length of each core cord comprising a twine are determined by the direction and density of twist.

The present invention paid attention to the fact that the contact angle and length of cords are dependent on the core cord twist angle, and thereby developed, and provides, a helical synchronous belt that resists thrust force.

The force resisting thrust force, being derived from each core cord buried in resin, is small and it is difficult to calculate this force individually. Therefore, the inventor created sample helical synchronous belts using core cords of different twist angles that consequentially provide different levels of force resisting thrust force, and used a pulley equipped with a strain gauge for measuring tracking force to determine the twist angles at which the belt tracking becomes small.

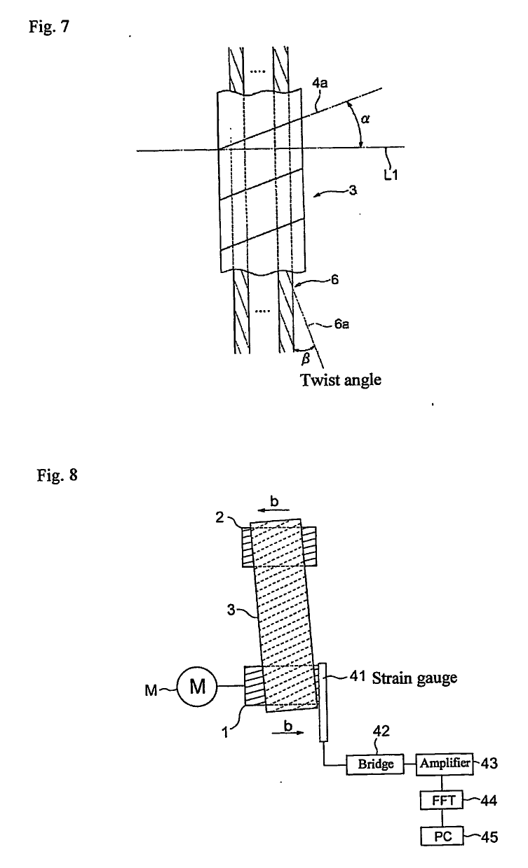

Here, the twist angle refers to the angle at which the cords comprising a twine are inclined with respect to the core cord direction. In FIG. 7, the twist angle is indicated by β.

The measurements show that although the twist angle of a conventional core cord is 18.9°, a positive effect was achieved in the twist angle range of 2° to 15° when the helical tooth angle and core cord twist angle were set in the same direction or opposite directions.

FIG. 7 gives a schematic drawing of a belt's helical tooth angle and core cord twist angle. When FIG. 7 is used as an example, the relationship of helical tooth angle and core cord twist angle is such that the helical tooth is inclined upward in clockwise direction at angle α, while the core cord is twisted upward in counterclockwise direction at angle β (that is, this cord is a left-handed twist).

In the helical synchronous belt (3) shown in FIG. 7, angle α formed by the pulley axial direction line (L1) and helical tooth inclination line (4a) gives the helical tooth angle, while angle β formed by the twist inclination line (6a) of the cords comprising the twine (6) and the direction of the core cord gives the twist angle.

The synthetic resin used in the teeth and back layer comprising the helical synchronous belt may be any commonly used material. For example, urethane rubber is used in the example.

The core cords can also be made of any commonly used material. In the example, the core cords are made by twisting polyaramid and grass fibers together.

A device to measure tracking force is shown in FIG. 8.

FIG. 8 illustrates the measurement of tracking force using a strain gauge.

A strain gauge (41) is installed on the free end of a driving pulley (1) controlled by a motor (M), and a helical synchronous belt (3) is turned around the pulleys. The pressure received by the stain gauge (41) as a result of the generated rust force is detected and amplified by a bridge (42) and amplifier (43) to be analyzed/displayed by an analyzer FFT (44) and then output to a PC (45).

<Example of Measurement>

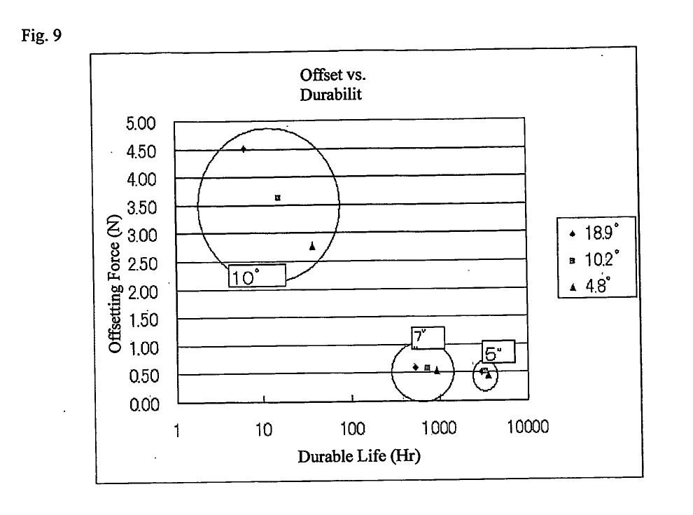

Table 1 and FIG. 9 show the measured results of tracking force and durability based on helical tooth angles of 10°, 7° and 5° and cord twist angles of 18.9°, 10.2° and 4.8°, respectively.

Durability was measured as the number of passes achieved until the belt became no longer usable due to tearing or breaking.

Relationship of Cord Twist Angle and Tracking Force, and Durability

TABLE 1

| | | Tracking force by core | | |
|---|---|---|---|---|
| | Durability | cord specification (N) | | |
| Helical | 10,000's of | Twist | Twist | Twist |
| tooth angle | passes | angle A | angle B | angle C |
| Deg | (laps) × 10⁴ | 18.9° | 10.2° | 4.8° |
| 10 | 6.4 | 4.51 | | |
| | 15 | | 3.63 | |
| | 36 | | | 2.75 |
| 7 | 534 | 0.59 | | |
| | 745 | | 0.57 | |
| | 925 | | | 0.52 |
| 5 | 3000 | 0.51 | | |
| | 3300 | | 0.50 | |
| | 3500 | | | 0.44 |

As for the test results, when the helical tooth angle was 10°, the tracking force was 4.51 N at the conventional twist angle of 18.9°, but it dropped to 3.63 N at a twist angle of 10.2°, and decreased significantly to 2.75 N at a twist angle of 4.8°. On the other hand, the durability increased from 64,000 passes with the conventional twist angle to 150,000 passes (more than twice) and 360,000 passes (more than five times), respectively.

When the helical tooth angle was 7°, the tracking force was 0.59 N at the conventional twist angle of 18.9°, but it was 0.57 N at a twist angle of 10.2°, and 0.52 N at a twist angle of 4.8°. The durability increased from 5,340,000 passes with the conventional twist angle to 7,450,000 passes (2,000,000 passes more) and 9,250,000 passes (4,000,000 passes more), respectively.

When the helical tooth angle was 5°, the tracking force was 0.51 N at the conventional twist angle of 18.9°, but it was 0.50 N at a twist angle of 102°, and 0.44 N at a twist angle of 4.8°. The durability increased from 30,000,000 passes to 33,000,000 passes and 35,000,000 passes, respectively.

A large helical tooth angle is effective in reducing noise, but durability also drops. In the present invention, however, the larger the helical tooth angle, the smaller the tracking force becomes and longer the belt life becomes. At a medium helical tooth angle of 7°, the tracking force is significantly smaller than the level at a helical tooth angle of 10°, and the belt life is also very long. When the twist angle is reduced, the actual belt life increases considerably although the change in tracking force is minimal.

By the way, a minimum twist angle of approx. 2° is needed to bundle core cords into a twine core cord.

FIG. 9 shows the relationship of tracking force and durability at helical tooth angles of 10°, 7° and 5°and twist angles of 18.9°, 10.2° and 4.8°. The vertical axis indicates tracking force in N, 25 while the horizontal axis indicates belt life in hours.

The graph supports the above results, showing that the larger the helical tooth angle, the smaller the tracking force becomes and longer the belt life becomes as the twist angle decreases. At a twist angle of 7° or 4.8°, the belt life can be extended effectively.

A carriage driving belt is subject to rubbing against flanges and skipped teeth, because the belt moves back and force with the carriage fixed on it. As a result, printing quality will drop over time. By changing the cord twist angle in line with the helical tooth angle, the durability until skipped teeth occur can be increased.

### INDUSTRIAL FIELD OF APPLICATION

The present invention successfully reduced the tracking force of a helical synchronous belt and improved the belt durability. When this belt is used as a carriage belt for printer, etc., stable printing quality can be achieved at low noise.

The larger the helical tooth angle, the smaller the tracking force becomes and higher the durability becomes as the twist angle decreases. When a helical tooth angle is small, reducing the twist angle improves the durability of the belt and extends its service hours.

1. A method for producing a helical synchronous belt for driving carriage, wherein said helical synchronous belt comprises a back layer, teeth and core cords which are made of a synthetic resin, said method comprising the steps of:
measuring a thrust force exerted on the helical synchronous belt due to a twist angle of the core cord using a strain gauge provided on a driving pulley; and
determining a helical tooth angle and core cord twist angle based on the measured thrust force.

2. A helical synchronous belt having its core cords twisted at an angle opposing to the angle of helical teeth, with the helical tooth angle set to 5° to 15° and core cord twist angle set to 15° to 2°.

3. The helical synchronous belt as described in claim 2, which has a helical tooth angle of 10°, 7° or 5° and core cord twist angle of 10.2° or 4.8°.

4. The helical synchronous belt as described in claim 2, comprising its back layer and teeth made of urethane resin and its core cords made of aramid fiber or glass fiber.

5. The helical synchronous belt as described in claim 2, which is used for driving carriage.

6. The helical synchronous belt as described in claim 3, comprising its back layer and teeth made of urethane resin and its core cords made of aramid fiber or glass fiber.

7. The helical synchronous belt as described in claim 3, which is used for driving carriage.

8. The helical synchronous belt as described in claim 4, which is used for driving carriage.

9. The helical synchronous belt as described in claim 6, which is used for driving carriage.

10. A helical synchronous belt comprising:
a back layer;
helical teeth configured to mesh with a pulley and arranged at a helical tooth angle which is formed by a tooth inclination line of each helical tooth and a line perpendicular to a longitudinal direction of the belt; and
core cords embedded between the back layer and the teeth and aligned in the longitudinal direction of the belt for reinforcing the belt, said core cords being twisted at a twist angle which is formed by a twist inclination line of each core cord and a line parallel to a longitudinal direction of the core cords,
wherein a direction of the tooth inclination line and a direction of the twist inclination line are opposite to each other with respect to the line perpendicular to the longitudinal direction of the belt, and the helical tooth angle and the twist angle are set at 5° to 15° and 2° to 15°, respectively.

11. The helical synchronous belt as described in claim 10, wherein the helical tooth angle is set at 5°, 7°, or 10° and the core cord twist angle is set at 4.8° or 10.2°.

12. The helical synchronous belt as described in claim 10, wherein the back layer and the helical teeth are made of urethane resin, and the core cords are made of aramid fiber or glass fiber.

13. The helical synchronous belt as described in claim 10, which comprises no canvas formed on the helical teeth.
